(19) United States
(12) Patent Application Publication
(10) Pub. No.: US 2024/0267158 A1
(43) Pub. Date: Aug. 8, 2024

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventors: Zhe FU, Dongguan (CN); Qianxi LU, Dongguan (CN)

(73) Assignee: GUANGDONG OPPO MOBILE TELECOMMUNICATIONS CORP., LTD., Dongguan (CN)

(21) Appl. No.: 18/637,123

(22) Filed: Apr. 16, 2024

Related U.S. Application Data
(63) Continuation of application No. PCT/CN2021/125891, filed on Oct. 22, 2021.

(51) Int. Cl. H04L 1/1812; H04L 1/08; H04L 1/1867; H04W 72/21; H04W 80/02

(52) U.S. Cl. CPC H04L 1/1812; H04L 1/08; H04L 1/1887; H04W 72/21; H04W 80/02

(57) ABSTRACT

A communication method includes: a terminal device receives first information including at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and the terminal device selects a target HARQ process corresponding to the CG resource according to the first information. The HARQ process selection manner is used for indicating the terminal device to preferentially select an HARQ process for retransmission or an HARQ process with a higher priority.

### CROSS-REFERENCE TO RELATED APPLICATION

This application is a continuation of International Application No. PCT/CN2021/125891 filed on Oct. 22, 2021, the disclosure of which is hereby incorporated by reference in its entirety.

### BACKGROUND

With the development of the communication technology, a Configured Grant Retransmission Timer (CGRT) is introduced into some communication systems to solve a problem of automatic retransmission of a resource when a Configured Grant (CG) resource cannot be transmitted due to the failure of Listening Before Talk (LBT). However, it is not clear how to perform the retransmission after the CGRT is introduced.

### SUMMARY

The present disclosure relates to the technical field of communications, and in particular to, a communication method and a communication device.

The present disclosure provides a communication method and a communication device, which can ensure the proper transmission of services.

In a first aspect, there is provided a communication method, including: a terminal device receives first information, where the first information includes at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and the terminal device selects a target HARQ process corresponding to the CG resource according to the first information, where the HARQ process selection manner is used for indicating the terminal device to preferentially select an HARQ process for retransmission or an HARQ process with a higher priority.

In a second aspect, there is provided a communication device, including: a processor, a memory and a transceiver. The memory is configured to store computer-executable instructions. The processor is configured to invoke and run the computer-executable instructions stored in the memory to perform operations of: receiving, through the transceiver, first information, wherein the first information comprises at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and selecting a target HARQ process corresponding to the CG resource according to the first information. The HARQ process selection manner is used for indicating the device to preferentially select an HARQ process for retransmission or an HARQ process with a higher priority.

In a third aspect, there is provided a chip including a processor configured to invoke programs from a memory, to enable a device on which the chip is mounted to perform operations of: receiving first information, wherein the first information comprises at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and selecting a target HARQ process corresponding to the CG resource according to the first information. The HARQ process selection manner is used for indicating the device to preferentially select an HARQ process for retransmission or an HARQ process with a higher priority.

### BRIEF DESCRIPTION OF THE DRAWINGS

FIG. 1 is an example diagram of a wireless communication system to which embodiments of the present disclosure are applied.

FIG. 2 is a schematic flowchart of a communication method according to an embodiment of the present disclosure.

FIG. 3 is a schematic flowchart of a communication method according to another embodiment of the present disclosure.

FIG. 4 is a schematic flowchart of a communication method according to yet another embodiment of the present disclosure.

FIG. 5 is a schematic structural diagram of a communication device according to an embodiment of the present disclosure.

FIG. 6 is a schematic structural diagram of a communication device according to another embodiment of the present disclosure.

FIG. 7 is a schematic structural diagram of a communication device according to another embodiment of the present disclosure.

FIG. 8 is a schematic structural diagram of a device according to an embodiment of the present disclosure.

### DETAILED DESCRIPTION

The technical schemes of the present disclosure will be described in conjunction with the accompanying drawings.

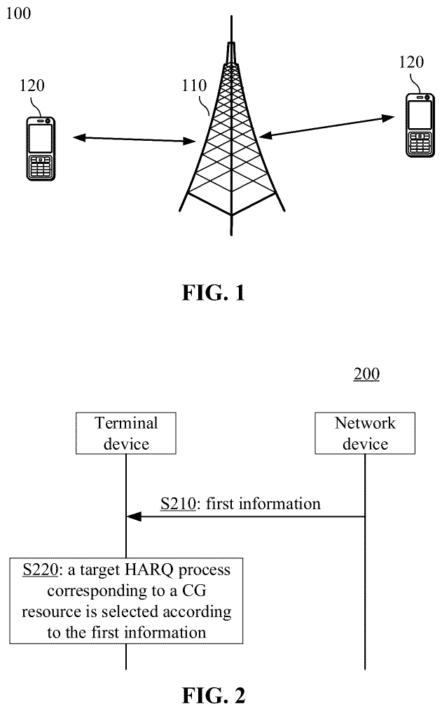

FIG. 1 is a wireless communication system 100 to which embodiments of the present disclosure are applied. The wireless communication system 100 may include a network device 110 and User Equipment (UE) 120. The network device 110 may communicate with the UE 120. The network device 110 may provide communication coverage for a particular geographic area and may communicate with terminal devices located within the coverage. The UE 120 may access a network (e.g. a wireless network) through the network device 110.

FIG. 1 exemplarily illustrates one network device and two terminal devices. In some embodiments, the communication system 100 may include multiple network devices, and other numbers of terminal devices may be included within the coverage of each network device, which is not limited by the embodiments of the present disclosure. Optionally, the communication system 100 may also include other network entities, such as, network controllers, mobility management entities, etc., which are not limited by the embodiments of the present disclosure.

It should be understood that the technical scheme of the embodiments of the present disclosure may be applied to various communication systems, such as the 5th-Generation (5G) system or the New Radio (NR) system, the Long Term Evolution (LTE) system, the LTE Frequency Division Duplex (FDD) system, the LTE Time Division Duplex (TDD), etc. The technical scheme provided by the present disclosure can also be applied to future communication systems, such as, the 6-th generation mobile communication system, the satellite communication system, etc.

The UE in the embodiments of the present disclosure may also be referred to a terminal device, an access terminal, a subscriber unit, a subscriber station, a Mobile Station (MS), a Mobile Terminal (MT), a remote station, a remote terminal, a mobile device, a user terminal, a terminal, a wireless communication device, a user agent or a user device. The UE in the embodiments of the present disclosure may be a device that provides voice and/or data connectivity to a user, and may be used to connect people, objects and machines, such as a handheld device with wireless connection function, a vehicle-mounted device, etc. The UE in the embodiments of the present disclosure may be a mobile phone, a tablet computer (or Pad), a notebook computer, a palmtop computer, a Mobile Internet Device (MID), a wearable device, a Virtual Reality (VR) device, an Augmented Reality (AR) device, a wireless terminal in industrial control, a wireless terminal in self driving, a wireless terminal in remote medical surgery, a wireless terminal in smart grid, a wireless terminal in transportation safety, and a wireless terminal in smart city, a wireless terminal in smart home, etc. Optionally, the UE may be used to act as a base station. For example, the UE may act as a scheduling entity that provides sidelink signals between UEs in the Vehicle to Everything (V2X) or the Device to Device (D2D) or the like. For example, a cellular phone communicates with a car by using the sidelink signals. The cellular phone communicates with the device in smart home without relaying communication signals by the base station.

The network device in the embodiments of the present disclosure may be a device configured to communicate with a UE, and the network device may also be referred to as an access network device or a radio access network device, for example, the network device may be a base station. The network device in the embodiments of the present disclosure may refer to a radio access network (RAN) node (or device) that accesses a UE to a wireless network. The base station may broadly cover or be replaced with following names, such as, Node B (NodeB), evolved NodeB (eNB), next generation NodeB (gNB), relay station, access point, Transmitting and Receiving Point (TRP), Transmitting Point (TP), Master eNB (MeNB), Secondary eNB (SeNB), Multi-Standard Radio (MSR) node, home base station, network controller, access node, wireless node, Access Point (AP), transmission node, transceiver node, Base Band Unit (BBU), Remote Radio Unit (RRU), Active Antenna Unit (AAU), Remote Radio Head (RRH), Central Unit (CU), Distributed Unit (DU), positioning node, etc. The base station may be a macro base station, a micro base station, a relay node, a donor node or a combination thereof.

In some embodiments, the network device may be fixed or mobile. For example, a helicopter or unmanned aerial vehicle may be configured to act as a mobile network device and one or more cells may be moved according to the location of the mobile network device. In other examples, the helicopter or unmanned aerial vehicle may be configured to function as a device that communicates with another network device. In some embodiments, the network device may be a CU or a DU, or the network device may include a CU and a DU, or the network device may also include an AAU.

It should be understood that the terminal device may be deployed on land, and include indoor or outdoor device, hand-held device or vehicle-mounted device. The terminal device may also be deployed in airplanes, in balloons and in satellites in the air. The scenario to which the embodiments of the present disclosure apply and where the network device is located is not limited in the embodiment of the present disclosure.

It should also be understood that all or part of the functions of the network device and UE in the present disclosure may also be implemented by software functions running on the hardware or by virtualized functions instantiated on a platform (e.g. a cloud platform).

The CGRT is introduced into some communication systems to solve the problem of the automatic retransmission of the resource when the CG resource cannot be transmitted due to the failure of the LBT. However, at present, it is not clear how to select an HARQ process to perform the retransmission after the CGRT is introduced.

Moreover, for an application or a service, when a Survival Time (ST) is represented by consecutive data packets that are transmitted erroneously, it is assumed ST=X. If the consecutive X data packets that are transmitted erroneously are present, the transmission error for the communication service occurs. Therefore, when consecutive X−1 data packets are failed to be transmitted, the last data packet must be transmitted successfully. However, it is not clear how to control a corresponding counter and timer to determine whether to enter an ST state.

In order to solve the above technical problems, the embodiments of the present disclosure will be explained in detail with reference to FIG. 2 to FIG. 4.

FIG. 2 is a schematic flowchart of a communication method according to an embodiment of the present disclosure. It should be understood that FIG. 2 illustrates steps or operations of the communication method, but these steps or operations are only examples. Furthermore, in the embodiments of the present disclosure, other operations or variations of all operations in FIG. 2 may also be performed, or not all of the steps need to be performed, or the steps may be performed in other orders. The method 200 shown in FIG. 2 may include operations S210 and S220.

In operation S210, a network device sends first information to a terminal device.

The first information may include at least one of: a position of a CG resource, an HARQ process corresponding to the CG resource, a CGRT or an HARQ process selection manner, and the HARQ process selection manner is used for indicating the terminal device to preferentially select an HARQ process for retransmission or an HARQ process with a higher priority.

In operation S220, the terminal device selects a target HARQ process corresponding to the CG resource according to the first information.

In some embodiments, the operation that the terminal device selects the target HARQ process corresponding to the CG resource according to the first information may include:
if the HARQ process selection manner is not configured, the first information does not include the HARQ process selection manner or the HARQ process selection manner indicates the terminal device to preferentially select the HARQ process for retransmission, the terminal device may preferentially select, among multiple HARQ processes, the HARQ process for retransmission as the target HARQ process.

An HARQ process corresponding to a Media Access Control Packet Data Unit (MAC PDU) with a lower priority is considered as the HARQ process for retransmission, or the HARQ process corresponding to the MAC PDU with the lower priority is considered to be a new transmission HARQ process.

In some embodiments, the operation that the terminal device selects the target HARQ process corresponding to the CG resource according to the first information may include:
if the HARQ process selection manner indicates the terminal device to preferentially select the HARQ process with the higher priority, the terminal device may preferentially select, among multiple HARQ processes, the HARQ process with the higher priority or an HARQ process corresponding to a higher Logical Channel Priority (LCP) as the target HARQ process.

In some embodiments, in a case where multiple preferential HARQ processes are present in the multiple HARQ processes, the operation that the terminal device selects the target HARQ process corresponding to the CG resource according to the first information may include:
the terminal device selects the target HARQ process according to any of following ways.

The terminal device selects, among the multiple preferential HARQ processes, any one HARQ process as the target HARQ process.

The terminal device selects, among the multiple preferential HARQ processes, an HARQ process with a smallest HARQ process index as the target HARQ process.

The terminal device selects, among the multiple preferential HARQ processes, an HARQ process with a greatest HARQ process index as the target HARQ process.

The terminal device selects, among the multiple preferential HARQ processes, the HARQ process for retransmission as the target HARQ process.

The terminal device selects, among the multiple preferential HARQ processes, a new transmission HARQ process as the target HARQ process.

The terminal device selects, among the multiple preferential HARQ processes, an HARQ process corresponding to an MAC PDU with a lower priority as the target HARQ process.

The terminal device selects, among the multiple preferential HARQ processes, an HARQ process corresponding to a user Data Radio Bearer (DRB) configured with a Survival Time (ST) as the target HARQ process.

The terminal device selects, among the multiple preferential HARQ processes, an HARQ process corresponding to a DRB with a higher ST requirement as the target HARQ process.

The terminal device selects, among the multiple preferential HARQ processes, an HARQ process corresponding to a DRB that will not satisfy an ST requirement within a preset period of time as the target HARQ process.

The terminal device selects, among the multiple preferential HARQ processes, an HARQ process having a number of HARQ retransmissions satisfying a first preset requirement as the target HARQ process.

The terminal device selects, among the multiple preferential HARQ processes, an HARQ process including Logical Channel (LCH) data as the target HARQ process.

The terminal device selects, among the multiple preferential HARQ processes, the target HARQ process based on an implementation of the terminal device.

In the above embodiment, the ST requirement may include a transmission delay requirement (e.g. the transmission delay requirement may be a length of ST) and/or a reliability requirement and the like. The DRB with the higher ST requirement may include a DRB with a transmission delay requirement less than or equal to a preset value, a DRB with a transmission delay requirement satisfying a preset requirement, and/or a DRB with a reliability requirement satisfying preset conditions. For example, an HARQ process corresponding to a DRB with the highest transmission delay requirement can be selected, among the multiple preferential HARQ processes, as the target HARQ process. Alternatively, an HARQ process corresponding to a DRB with the highest reliability requirement can also be selected, among the multiple preferential HARQ processes, as the target HARQ process. Alternatively, an HARQ process corresponding to a DRB with the highest transmission delay requirement and the highest reliability requirement can also be selected, among the multiple preferential HARQ processes, as the target HARQ process.

In the above embodiment, the DRB that will not satisfy the ST requirement within the preset period of time may also be understood as a DRB that is not about to satisfy the ST requirement (for example, within a shorter duration). For example, the DRB that will not satisfy the ST requirement within the preset period of time may be understood as a DRB that will not satisfy the ST requirement immediately, a DRB that does not satisfy the ST requirement within the preset period of time, or a DRB that will not satisfy the ST requirement after the preset period of time. For example, the DRB that will not satisfy the ST requirement within the preset period of time may be a DRB for which the transmission delay will be beyond the transmission delay requirement (e.g., the length of ST) within the preset period of time.

Optionally, the first preset requirement may be that: the number of HARQ retransmissions of the HARQ process is minimum; the number of HARQ retransmissions of the HARQ process is maximum; the number of HARQ retransmissions of the HARQ process is less than (or less than or equal to) a retransmission threshold; or the number of HARQ retransmissions of the HARQ process is greater than (or greater than or equal to) the retransmission threshold. Optionally, the fact that the terminal device selects, among the multiple preferential HARQ processes, the target HARQ process based on the implementation of the terminal device may mean that: the selection of the HARQ process from the multiple preferential HARQ processes as the target HARQ process completely depends on the implementation of the terminal device, i.e. the terminal device autonomously selects the target HARQ process among the multiple preferential HARQ processes.

In some embodiments, before the terminal device selects the target HARQ process according to the first information, the terminal device may determine, according to the first information, whether priorities of the HARQ processes are required to be determined.

For example, if the HARQ process selection manner is not configured, the first information does not include the HARQ process selection manner or the HARQ process selection manner indicates the terminal device to preferentially select the HARQ process for retransmission, the terminal device is not required to determine the priorities of the HARQ processes; and if the HARQ process selection manner indicates the terminal device to preferentially select the HARQ process with the higher priority, the terminal device is required to determine the priorities of the HARQ processes.

Optionally, if the priorities of the HARQ processes are required to be determined, the terminal device may determine the priorities of the HARQ processes.

For example, the terminal device may determine the priorities of the HARQ processes according to any one of following ways.

If data is contained or to be contained in the HARQ process, or if an LCH is multiplexed or to be multiplexed in the HARQ process, the priorities of the multiple HARQ processes are determined according to priorities of LCHs.

If only padding information and/or Media Access Control Control Elements (MAC CEs) are contained or to be contained in the HARQ process corresponding to the CG resource or in the HARQ process, or if no data is multiplexed or to be multiplexed in the HARQ process, or if no LCH is multiplexed or to be multiplexed in the HARQ process, the priorities of the multiple HARQ processes are determined according to a priority order of LCPs or a priority order of the MAC CEs.

If only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to a Scheduling Request (SR).

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but Uplink Control Information (UCI) is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.

Furthermore, the terminal device may select, among the multiple HARQ processes, the target HARQ process corresponding to the CG resource according to the priorities.

In the embodiment of the present disclosure, the first information includes at least one of: the position of the CG resource, the HARQ process corresponding to the CG resource, the CGRT or the HARQ process selection manner, and the terminal device can preferentially select the HARQ process for retransmission or the HARQ process with the higher priority according to the first information, so as to perform the retransmission when the CG resource cannot be transmitted, thereby ensuring the proper transmission of the services.

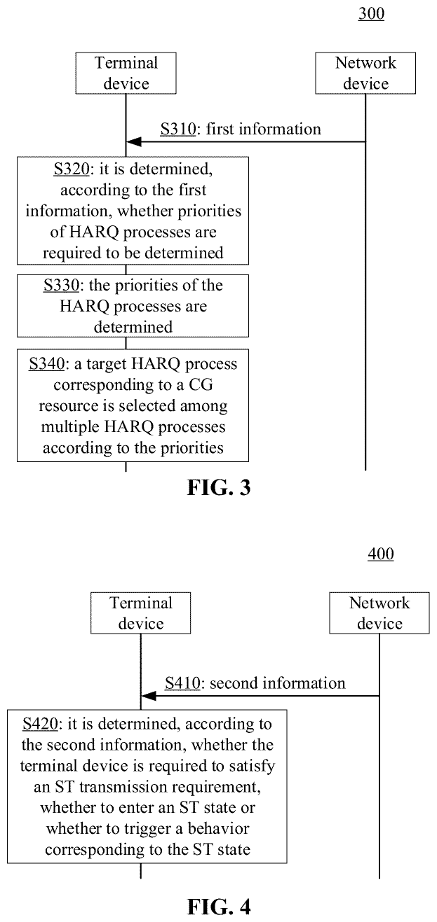

FIG. 3 is a schematic flowchart of a communication method according to an embodiment of the present disclosure. The method 300 shown in FIG. 3 may include operations S310 and S320.

In operation S310, a network device sends first information to a terminal device.

The first information may include at least one of: a position of a CG resource, an HARQ process corresponding to the CG resource, a CGRT or an HARQ process selection manner. The HARQ process selection manner is used for indicating the terminal device to preferentially select an HARQ process for retransmission or an HARQ process with a higher priority.

In operation S320, the terminal device determines, according to the first information, whether priorities of HARQ processes are required to be determined.

Optionally, if the HARQ process selection manner is not configured, the first information does not include the HARQ process selection manner or the HARQ process selection manner indicates the terminal device to preferentially select the HARQ process for retransmission, the terminal device is not required to determine the priorities of the HARQ processes; and if the HARQ process selection manner indicates the terminal device to preferentially select the HARQ process with the higher priority, the terminal device is required to determine the priorities of the HARQ processes.

In operation S330, the terminal device determines the priorities of the HARQ processes.

Optionally, if the priorities of the HARQ processes are required to be determined, the terminal device may determine the priorities of the HARQ processes.

For example, the terminal device may determine the priorities of the HARQ processes according to any one of following ways.

If data is contained or to be contained in the HARQ process, or if an LCH is multiplexed or to be multiplexed in the HARQ process, the priorities of the multiple HARQ processes are determined according to priorities of LCHs.

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, the priorities of the multiple HARQ processes are determined according to a priority order of LCPs or a priority order of the MAC CEs.

If only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to an SR.

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but Uplink Control Information (UCI) is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.

In operation S340, the terminal device selects, among multiple HARQ processes, a target HARQ process corresponding to the CG resource according to the priorities.

Optionally, the terminal device may adopt the methods in the various embodiments of the method 200 in FIG. 2 to select, among the multiple HARQ processes, the target HARQ process corresponding to the CG resource according to the priorities.

In the embodiment of the present disclosure, the terminal device may determine the priorities of the HARQ processes according to the first information, so that the terminal device may select, among the multiple HARQ processes, the target HARQ process corresponding to the CG resource according to the priorities, so as to perform the retransmission when the CG resource cannot be transmitted, thereby ensuring the proper transmission of the services.

FIG. 4 is a schematic flowchart of a communication method according to an embodiment of the present disclosure. The method 400 shown in FIG. 4 may include operations S410 and S420.

In operation S410, a terminal device receives second information.

The second information includes at least one of: an ST indication, an ST enable indication, a counter N, a maximum threshold of the counter N, a timer, an Identifier (ID) of a user DRB, an ID of a QoS flow or an ID of an LCH, where N is a positive number. Optionally, the second information may also include a CG resource or a DG resource used by the ST state.

Optionally, the DRB is configured with an ST ID. Optionally, the QoS flow is configured with the ST ID. Optionally, the LCH is configured with the ST ID.

Optionally, the maximum threshold of the counter N is determined according to at least one of: an ST, a Packet Delay Budget (PDB) or a Round Trip Time (RTT) duration. Optionally, the timer is determined according to at least one of the ST, the PDB or the RTT duration.

Optionally, there may be multiple pieces of second information, and each piece of second information is configured by a respective one of multiple information elements (IEs).

Optionally, the second information is carried in a Radio Resource Control (RRC) message, an MAC CE, Downlink Control Information (DCI), Packet Data Convergence Protocol (PDCP) configuration information, DRB configuration information or LCH configuration information.

Optionally, the second information is carried in at least one of: PDCP configuration information, Radio Bearer (RB) configuration information or LCH configuration information.

Optionally, the terminal device may determine an association relationship among the DRB, the LCH and a scheduling grant according to at least one of the PDCP configuration information, the RB configuration information or the LCH configuration information. Optionally, the determination of the association relationship among the DRB, the LCH and the scheduling grant may mean that: the terminal device determines, based on a mapping restriction in the second information, the LCH, the grant, and the HARQ process that are used by the DRB of ST (demand or behavior), so that when the HARQ-NACK is received, the terminal device may determine whether the counter N is incremented by 1 and/or whether duplication is to be triggered. Optionally, the configuration information may include the parameter allowedCG-List-r16 and/or the parameter allowedPHY-PriorityIndex-r16.

In operation S420, the terminal device determines, according to the second information, whether the terminal device is required to satisfy the ST transmission requirement, whether to enter the ST state or whether to trigger the behavior corresponding to the ST state.

Optionally, the behavior corresponding to the ST state includes duplication or activation of the duplication.

Optionally, the terminal device may determine, according to the second information, whether a target object triggers the behavior corresponding to the ST state, where the target object is the terminal device, the DRB, the QoS flow or the LCH.

In some embodiments, the terminal device may determine, according to the counter N and the timer, whether the terminal device is required to satisfy the ST transmission requirement, whether to enter the ST state or whether to trigger the behavior corresponding to the ST state.

For example, if the counter N reaches the maximum threshold before the timer expires, it is determined to satisfy the ST transmission requirement, to enter the ST state or to trigger the behavior corresponding to the ST state.

If an Acknowledge (ACK) is received before the timer expires, it is determined not to satisfy the ST transmission requirement, not to enter the ST state or not to trigger the behavior corresponding to the ST state.

If the timer expires or if the counter N does not reach the maximum threshold before the timer expires, it is determined not to satisfy the ST transmission requirement, not to enter the ST state or not to trigger the behavior corresponding to the ST state

In some embodiments, in a case it is determined to satisfy the ST transmission requirement, to enter the ST state or to trigger the behavior corresponding to the ST state, the terminal device may perform at least one of:
stopping the timer, resetting the counter N, entering the ST state, triggering the duplication, indicating by a Media Access Control (MAC) layer to an upper layer that a Negative Acknowledgement (NACK) is received, activating the duplication, or satisfying an ST entry state.

In some embodiments, if multiple data packet transmission errors are directed to a same data packet, or if the multiple data packet transmission errors are directed to a same HARQ process, or if the multiple data packet transmission errors are directed to a same data packet during running of the timer, or if the multiple data packet transmission errors are directed to a same HARQ process during running of the timer, the counter N is kept unchanged.

Optionally, if the multiple data packet transmission errors are directed to different data packets, or if the multiple data packet transmission errors are directed to different HARQ processes, or if the multiple data packet transmission errors are directed to different data packets during running of the timer, or if the multiple data packet transmission errors are directed to different HARQ processes during running of the timer, the counter N is incremented by 1.

In some embodiments, if a data packet transmission error is present before the timer expires, the counter N is incremented by 1.

For example, it is considered that the data packet transmission error is present when at least one of following conditions occurs.

A data packet is lost.

An HARQ-NACK is received.

A data packet corresponding to an ST is lost.

An HARQ-NACK corresponding to the ST is received.

The data packet is lost in a case where the timer is not running.

The HARQ-NACK is received in a case where the timer is not running.

The data packet corresponding to the ST is lost in a case where the timer is not running.

The HARQ-NACK corresponding to the ST is received in a case where the timer is not running.

In some embodiments, the timer is started when the terminal device performs at least one of the followings.

A data packet corresponding to an ST is sent.

A data packet is received from an upper layer.

A corresponding data packet is sent by a lower layer.

A data packet is lost.

An HARQ-NACK is received.

The data packet corresponding to the ST is discarded.

An HARQ-NACK corresponding to the ST is received.

In some embodiments, the counter N may be initialized when the terminal device performs at least one of followings.

A corresponding data packet is sent to a lower layer.

A data packet is received from an upper layer.

A lower layer sends a corresponding data packet.

A data packet is lost.

An HARQ-NACK is received.

A data packet corresponding to an ST is discarded.

An HARQ-NACK corresponding to an ST is received.

A data packet is discarded in a case where the timer is not running.

An HARQ-NACK is received in a case where the timer is not running.

A data packet corresponding to an ST is discarded in a case where the timer is not running.

An HARQ-NACK corresponding to an ST is received in a case where the timer is not running.

Expiry of the timer.

An ACK is received.

An ACK corresponding to an ST is received.

In some embodiments, if a lower layer receives a DRB corresponding to an ST or an NACK feedback associated with an LCH, the timer is started or the timer is restarted; if the DRB corresponding to the ST or a data packet associated with the LCH is received from the upper layer, the timer is started or the timer is restarted; and if the DRB corresponding to the ST or the data packet associated with the LCH is sent, the timer is started or the timer is restarted.

In some embodiments, the timer is directed to a corresponding data packet, or the timer is directed to a corresponding HARQ process, or the timer is directed to a corresponding CG resource. Optionally, the counter N may be maintained based on the timer or the counter N may be maintained for each timer.

In some embodiments, if one retransmission grant is received before the timer expires, the counter N may be incremented by 1; if one new transmission grant is received before the timer expires, the timer may be stopped; if the counter N reaches the maximum threshold before the timer expires, the timer may be stopped and/or the ST state may be entered, or the ST state may be triggered or the duplication may be triggered; and if the counter N does not reach the maximum threshold before the timer expires, the timer may be stopped.

In some embodiments, the method 400 further includes at least one of following operations. If multiple retransmission grants are directed to a same data packet, or if the multiple retransmission grants are directed to a same HARQ process, or if the multiple retransmission grants are directed to a same data packet during running of the timer, or if the multiple retransmission grants are directed to a same HARQ process during running of the timer, the counter N may be kept unchanged; or if the multiple retransmission grants are directed to different data packets, or if the multiple retransmission grants are directed to different HARQ processes, or if the multiple retransmission grants are directed to different data packets during running of the timer, or if the multiple retransmission grants are directed to different HARQ processes during running of the timer, the counter N may be incremented by 1.

Optionally, the timer is a Transmitter-side (TX-side) timer or a Receiver-side (RX-side) timer.

In some embodiments, if it is indicated by the lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer, the terminal device triggers the duplication.

In some embodiments, if a lower layer receives a DRB corresponding to an ST or an NACK feedback associated with an LCH, the terminal device may start the timer; if the DRB corresponding to the ST or a data packet associated with the LCH is received from the upper layer, the terminal device may start the timer; if the DRB corresponding to the ST or the data packet associated with the LCH is sent, the terminal device may start the timer.

Optionally, the timer is directed to a terminal device, or the counter N is maintained for each terminal device. For example, the terminal device maintains only one counter N at one moment.

Optionally, the timer is a TX-side timer or an RX-side timer.

Optionally, if one retransmission grant is received when the timer is not running, the counter N may be incremented by 1, and the timer may be started.

Optionally, the method includes at least one of following operations. If one retransmission grant is received during running of the timer, the counter N may be incremented by 1. If one new transmission grant is received during running of the timer, the timer may be stopped and the counter N may be reset. If the counter N reaches the maximum threshold before the timer expires, the counter N may be reset; and/or the timer may be stopped; and/or the ST state may be entered, the ST state may be triggered or the duplication may be triggered. If the counter N does not reach the maximum threshold before the timer expires, the counter N may be reset.

Optionally, if multiple retransmission grants are directed to a same data packet, or if the multiple retransmission grants are directed to a same HARQ process, or if the multiple retransmission grants are directed to a same data packet during running of the timer, or if the multiple retransmission grants are directed to a same HARQ process during running of the timer, the counter N may be kept unchanged. If the multiple retransmission grants are directed to different data packets, or if the multiple retransmission grants are directed to different HARQ processes, or if the multiple retransmission grants are directed to different data packets during running of the timer, or if the multiple retransmission grants are directed to different HARQ processes during running of the timer, the counter N may be incremented by 1.

Optionally, if it is indicated by a lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer, the terminal device may trigger the duplication.

In some embodiments, if a lower layer receives a DRB corresponding to an ST or an NACK feedback associated with an LCH, the timer may be started; if the DRB corresponding to the ST or a data packet associated with the LCH is received from the upper layer, the timer may be started; and if the DRB corresponding to the ST or the data packet associated with the LCH is sent, the timer may be started.

Optionally, the timer may be directed to each HARQ process, or the counter N may be maintained for each HARQ process.

Optionally, if one retransmission grant is received when the timer is not running, the counter N may be incremented by 1, and the timer may be started.

Optionally, the method 400 includes at least one of following operations. If one retransmission grant is received during running of the timer, the counter N may be incremented by 1. If one new transmission grant is received during running of the timer, the timer may be stopped and the counter N may be reset. If the counter N reaches the maximum threshold before the timer expires, the counter N may be reset; and/or the timer may be stopped; and/or the ST state may be entered, the ST state may be triggered or the duplication may be triggered. If the counter N does not reach the maximum threshold before the timer expires, the counter N may be reset.

Optionally, if multiple retransmission grants are directed to a same data packet, or if the multiple retransmission grants are directed to a same data packet during running of the timer, the counter N may be updated or maintained (e.g. the counter N may be incremented by 1). If the multiple retransmission grants are directed to different packets, or if the multiple retransmission grants are directed to different packets during running of the timer, the counter N may be kept unchanged.

Optionally, the timer may be a TX-side timer. Optionally, the timer may be a Configured Grant Timer (CGT).

Optionally, the timer is a TX-side timer or an RX-side timer.

Optionally, if it is indicated by a lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer, the terminal device triggers the duplication.

In some embodiments, the terminal device determines, according to the counter N, whether to enter the ST state or whether to trigger the behavior corresponding to the ST state.

Optionally, the behavior corresponding to the ST state includes duplication or activation of the duplication.

Optionally, if one retransmission grant is received, the counter N may be incremented by 1; if one new transmission grant is received, the counter N may be reset; and if the counter N reaches the maximum threshold, the counter N may be reset; and/or the ST state may be entered, the ST state may be triggered or the duplication may be triggered.

Optionally, if multiple retransmission grants are directed to a same data packet, or if the multiple retransmission grants are directed to a same HARQ process, or if the multiple retransmission grants are directed to a same data packet during running of the timer, or if the multiple retransmission grants are directed to a same HARQ process during running of the timer, the counter N may be kept unchanged. If the multiple retransmission grants are directed to different data packets, or if the multiple retransmission grants are directed to different HARQ processes, or if the multiple retransmission grants are directed to different data packets during running of the timer, or if the multiple retransmission grants are directed to different HARQ processes during running of the timer, the counter N may be incremented by 1.

Optionally, if it is indicated by a lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer, the terminal device triggers the duplication.

In the embodiment of the present disclosure, the terminal device may control the corresponding counter and/or timer according to the second information, and determine, according to the counter and/or timer, whether the terminal device is required to satisfy the ST transmission requirement, whether to enter the ST state or whether to trigger the behavior corresponding to the ST state, so that the ST requirement of the service transmission can be guaranteed.

Embodiments of the present disclosure may also include multiple embodiments described as follows.

When the Ultra Reliability and Low Latency Communication (URLLC) is used in the unlicensed band, if a CGRT is configured, for one CG, when the HARQ process is selected, HARQ process for retransmission may be preferentially selected, or an HARQ process with a higher priority may also be preferentially selected. However, there are still some details that are unclear. Specifically, there are following two problems.

Regarding the first problem, for the first point: how to select an HARQ process when there are multiple preferential HARQ processes or when the preferential HARQ processes have the same priority (which corresponds to the following first embodiment); for the second point: how to consider the priority of an HARQ process when no LCH is multiplexed or to be multiplexed in the HARQ process (which corresponds to the following second embodiment).

Regarding the second problem, some details are not clear when the entry of the ST state is triggered by the HARQ-NACK. These details include: how to set the corresponding control counter and how to judge whether the control counter is incremented by 1 when the entry of the ST state is judged by using the HARQ-NACK (which corresponds to the following third embodiment).

The first embodiment (a method for selecting an HARQ process when multiple preferential HARQ processes are present or when the preferential HARQ processes have the same priority)

The specific implementation flow is as follows.

1. A network configures a CG resource, which includes:
a) a position of the CG resource;
b) an HARQ process corresponding to the CG resource;
c) a CGRT; and
d) an HARQ process selection manner (i.e., when the URLLC is used in unlicensed band, or when the LCH-based prioritization and the CGRT are configured, or when the CGRT is configured, for the CG, when the HARQ process is selected, whether the HARQ process for retransmission or an HARQ process with a higher priority is preferentially selected).

2. UE receives network configuration information and transmits the resource. This operation includes selecting an HARQ process.

a) If the HARQ process selection manner is not configured or not present; or if the HARQ process selection manner indicates to the UE that the retransmission is preferential, then the UE selects the HARQ process to be used for the corresponding CG in the manner of preferentially selecting the HARQ process for retransmission.

i. Optionally, an HARQ process corresponding to an MAC PDU with a lower priority is considered as the HARQ process for retransmission, or considered as the new transmission HARQ process.

b) If the HARQ process selection manner indicates to the UE that the HARQ process with the higher priority is preferential, then the UE selects the HARQ process used for the corresponding CG in the manner of preferentially selecting the HARQ process with the higher priority or selecting the HARQ process corresponding to a higher Logical Channel Priority (LCP).

i. Optionally, when the multiple preferential HARQ processes are present or when the preferential HARQ processes have the same priority, the UE selects the corresponding HARQ process by at least one of following ways:
selecting one HARQ process, or, any one HARQ process according to an implementation of the UE;
selecting an HARQ process with a smaller HARQ process index, or selecting an HARQ process with a greater HARQ process index;
selecting the HARQ process for retransmission (furthermore, if there are multiple HARQ process for retransmissiones, which one will be selected depends on the implementation of the UE);
selecting the new transmission HARQ process (furthermore, if there are multiple new transmission HARQ processes, which one will be selected depends on the implementation of the UE; or if there are multiple new transmission HARQ processes, the HARQ process corresponding to the MAC PDU with the lower priority is selected);
selecting the HARQ process corresponding to the MAC PDU with the lower priority;
selecting an HARQ process corresponding to a user DRB configured with the ST;
selecting an HARQ process corresponding to a DRB with a higher ST requirement (such as the higher delay requirement), or selecting an HARQ process corresponding to the DRB that will not satisfy the ST requirement (such as a DRB beyond an Access Network Packet Delay Budget (AN-PDB) or beyond the length of ST).
selecting an HARQ process with the minimum or the maximum number of retransmissions, or selecting an HARQ process with the number of retransmissions less than or greater than the retransmission threshold; or
selecting the HARQ process including the LCH data.

The embodiment has the beneficial effect that the first point of the first problem is solved, and the requirement for the service transmission is guaranteed.

The second embodiment (a method for setting the priorities of the HARQ processes when only padding and/or MAC CEs (or the specific MAC CE) are contained or to be contained in the HARQ process).

The specific implementation flow is as follows.

1. A network configures a CG resource, which includes:
a) a position of the CG resource;
b) an HARQ process corresponding to the CG resource;
c) a CGRT; and
d) an HARQ process selection manner (i.e., when the URLLC is used in unlicensed band; or when the LCH-based prioritization and the CGRT are configured; or when the CGRT is configured, for the CG, when the HARQ process is selected, whether the HARQ process for retransmission or an HARQ process with a higher priority is preferentially selected).

2. UE receives network configuration information and transmits the resource. This operation includes setting the priorities of the HARQ processes.

a) If the HARQ process selection manner is not configured or not present; or if the HARQ process selection manner indicates to the UE that the retransmission is preferential, then the UE is not required to set the priorities of the HARQ processes.

i. Optionally, the HARQ process corresponding to the MAC PDU with the lower priority is considered as the HARQ process for retransmission, or considered as the new transmission HARQ process.

b) If the HARQ process selection manner indicates to the UE that the HARQ process with the higher priority is preferential, then the UE sets the priorities of the HARQ processes. Alternatively, the UE sets the priorities of the HARQ processes regardless of whether there is an indication of the HARQ process selection manner.

i. Optionally, if data is contained or to be contained in the HARQ process, or if the LCH is multiplexed or to be multiplexed in the HARQ process, then the priorities of the multiple HARQ processes are determined according to priorities of LCHs.

ii. Optionally, if only padding and/or MAC CEs (or the specific MAC CE) are contained or to be contained in the HARQ process corresponding to a grant or in the HARQ process, or if no LCH is multiplexed or to be multiplexed in the HARQ process, the priorities of the multiple HARQ processes are determined according to a priority order of LCPs.

iii. Optionally, if only padding and/or MAC CEs (or the specific MAC CE) are contained or to be contained in the HARQ process corresponding to a grant or in the HARQ process, or if no LCH is multiplexed or to be multiplexed in the HARQ process, then it is considered that a priority of the HARQ process is low, or the priority of the HARQ process is lower than a priority of the HARQ process where the LCH is multiplexed or to be multiplexed, or the priority of the HARQ process is lower than a priority of a Scheduling Request (SR). Optionally, the MAC entity discards the MAC PDU.

iv. Optionally, if only padding and/or MAC CEs (or the specific MAC CE) are contained or to be contained in the HARQ process corresponding to a grant or in the HARQ process, or if no LCH is multiplexed or to be multiplexed in the HARQ process, but the UCI is multiplexed in the HARQ process (i.e. the CG-UCI is present), then a priority of the HARQ process is a specific priority, or it is considered that the priority of the HARQ process is low, or the priority of the HARQ process is lower than the priority of the HARQ process where the LCH is multiplexed or to be multiplexed, or the priority of the HARQ process is lower than the priority of the SR. Optionally, the MAC entity discards the MAC PDU.

The embodiment has the beneficial effect that the second point of the first problem is solved, and the requirement for the service transmission is guaranteed.

The third embodiment (a method for setting the corresponding control counter when a feedback from the network (such as the HARQ-NACK) is adopted to judge the entry of the ST state).

The specific implementation flow is as follows.

1) A serving cell indicates a first parameter to the UE, and the first parameter is used for the judgment of the entry of the ST state or whether the UE triggers the behavior corresponding to the ST, such as triggering the duplication. Details are as follows.

a. The first parameter includes at least one of: an ST indication, an ST enabler indication, a counter N, a maximum threshold of the counter N, a timer, an Identifier (ID) of a DRB, an ID of a QoS flow or an ID of an LCH.

b. Optionally, the first parameter includes a DRB with an ST ID, or an LCH with the ST ID or a QoS flow with the ST ID.

c. Optionally, when counter N is configurable, the parameter N is included in the first parameter. Otherwise, the parameter N may be included in the first parameter or may also be predefined. Optionally, N=1.

d. Optionally, the first parameter includes the used CG resource corresponding to the entry of the ST state.

i. For example, the mapping relationship between the LCH (DRB) and the CG is configured, and the CG resource is configured, so that the UE may know the CG resource used by the object (i.e., the DRB, the QoS flow, or the LCH) of the first parameter (such as the ST).

ii. Optionally, the CG resource includes a CG Type 1 and/or a CG Type 2.

iii. Optionally, when the CG resource is used, there is also a HARQ process number that is restricted to be used.

iv. Optionally, the CG resource may also be replaced with the DG resource.

e. The maximum threshold and/or the timer are determined according to at least one of: the Survival Time (ST), or the Packet Delay Budget (PDB).

f. Furthermore, the UE receives the first information indicated by the network and determines whether to perform the judgment of the entry of the ST state, or whether the UE triggers the behavior corresponding to the ST, such as, triggering the duplication.

a. The first parameter and/or the first information may be indicated to the UE through dedicated information, such as the RRC, the MAC CE, the DCI, or may be broadcast to the UE. Optionally, the first parameter and/or the first information may be carried in the PDCP-config, the DRB-config or the LCH-config.

2) The UE receives the message in 1); and the UE performs the judgment of the entry of the ST state, or whether to trigger the behavior corresponding to the ST, such as triggering the duplication, which is specifically as follows.

a. For one object, the UE performs the judgment, or determines whether to trigger the behavior corresponding to the ST.

i. The object is one of: the UE, the DRB, the QoS flow or the LCH.

b. The method for determining whether to trigger the behavior corresponding to the ST is based on the counter N and/or the timer.

c. Optionally, for an HARQ process for which an ACK is not received, the UE considers the feedback of the HARQ process as the ACK or considers that the transmission corresponding to the HARQ process is successful.

d. Optionally, the behavior of the UE includes at least one of: starting the timer, resetting the timer, the behavior of the expiry of the timer, maintaining the counter N, resetting the counter, initializing the counter, indicating the behavior related to the ST to the upper layer.

e. Optionally, for the feedback from the network, such as, the HARQ-NACK, the counter N counts for different HARQ processes. That is to say, if multiple NACK feedbacks received by the UE are directed to one HARQ process, or if multiple NACK feedbacks received by the UE are directed to one HARQ process during running of the timer (within a period of time), the UE considers that the counter is only incremented by 1.

f. Optionally, the first example of the judgment flow includes at least one of the followings.

i. The counter N is initialized to a specific value, such as 1 or 0.

ii. In the first condition, the counter N is initialized. The first condition includes at least one of the following conditions.
A corresponding data packet is sent to a lower layer. For example, the PDCP sends the PDCP data PDU or the PDCP data PDU corresponding to ST to the lower layer.
A packet is received from an upper layer. For example, the PDCP receives the packet or a packet corresponding to the ST.
A lower layer sends a corresponding data packet. For example, the MAC sends the MAC PDU or the MAC PDU corresponding to the ST.
A data packet is lost, or an HARQ-NACK is received, or a data packet corresponding to an ST is lost, or an HARQ-NACK corresponding to an ST is received.
In a case where the timer is not running, a data packet is lost, or an HARQ-NACK is received, or a data packet corresponding to an ST is lost, or an HARQ-NACK corresponding to an ST is received.
The counter N is set and maintained at the MAC layer.

iii. In the first case, the timer is started. The first condition includes at least one of the following conditions.
A packet (e.g., a PDCP data PDU) corresponding to an ST is sent.
A packet is received from an upper layer. For example, the PDCP receives the packet or a packet corresponding to the ST.
A corresponding data packet is sent by a lower layer. For example, the MAC sends the MAC PDU or the MAC PDU corresponding to the ST.
A data packet is discarded, or an HARQ-NACK is received, or the data packet corresponding to the ST is discarded, or an HARQ-NACK corresponding to the ST is received.
The timer is started and maintained at the MAC layer

iv. If a packet transmission error is present, the counter is incremented by 1.
It is considered that the data packet transmission error is present when at least one of following conditions occurs: losing a data packet; receiving an HARQ-NACK; losing a data packet corresponding to an ST; receiving an HARQ-NACK corresponding to the ST; losing the data packet in a case where the timer is not running; receiving the HARQ-NACK in a case where the timer is not running; losing the data packet corresponding to the ST in a case where the timer is not running; or receiving the HARQ-NACK corresponding to the ST in a case where the timer is not running.
The counter is reset if one ACK is received, or if a packet is considered to have been successfully transmitted.
The counter is reset when at least one of following occurs: the ST state is entered, the PDCP duplication is triggered, the MAC indicates to the upper layer that the NACK is received, or the duplication is activated.
If the counter N reaches the threshold, the UE performs at least one of: stopping the timer, resetting the counter N to 0, entering the ST state, triggering the PDCP duplication, indicating by the MAC layer to an upper layer that the NACK is received or activating the duplication.
The data packet transmission error is determined at the MAC layer.

v. The timer counter N is counted during running of the timer.
if a data packet transmission error is present before the timer expires, the counter N is incremented by 1.
If N reaches the threshold before the timer expires, the UE performs at least one of: stopping the timer, resetting the counter N to 0, entering the ST state, triggering the PDCP duplication, indicating by the MAC layer to an upper layer that the NACK is received, or activating the duplication.
The counter is reset when at least one of following occurs: the ST state is entered, the PDCP duplication is triggered, the MAC indicates to the upper layer that the NACK is received, or the duplication is activated.
If an ACK is received before the timer expires, the timer is stopped and/or the counter is reset.
If the timer expires, or if the N does not reach the maximum threshold before the timer expires, the ST is considered to be satisfied, or the counter N is reset.

vi. N is incremented by 1: for the NACK of the first retransmission, N+1 is performed, or for the subsequent NACKs for the same HARQ or the same MAC PDU (i.e. multiple retransmissions), N+1 is not performed.

g. Optionally, the second example of the judgment flow includes at least one of the followings (N is maintained individually with each timer).

In operation 1, the network configures ST support parameters for one DRB in the RRC message, where the ST support parameters include the counting number N and the TX-side timer.

In operation 2, the UE MAC performs counting mechanism for ST entering judgment. The details are as follows.
ST_COUNTER, a new UE variable associated with the TX-side timer for consecutive HARQ-NACKs calculation, is initially set to 0.
One TX-side timer is maintained for one data packet with the ST requirement. The TX-side timer is started (or restarted) when the packet associated with the DRB configured with the ST support parameters is delivered to the lower layer.
If one retransmission grant is received before the TX-side timer expires, the ST_COUNTER is incremented by 1.
If a new transmission grant is received before the TX-side timer expires, the TX-side timer is stopped.
If the ST_COUNTER≥N before the TX-side timer expires, the TX-side timer is stopped and the upper layer is indicated to activate the PDCP duplication.
If the ST_COUNTER≤N before the TX-side timer expires, the TX-side timer is stopped.

In operation 3, the UE layer activates PDCP duplication once PDCP duplication activation indication, e.g. ST support indication, is received from the lower layer.

i. Optionally, the ST_COUNTER and/or the timer may not be maintained when N=1. Correspondingly, when the NACK indication is received, the MAC layer of the UE indicates the upper layer to activate the PDCP duplication.

h. Optionally, the third example of the judgment flow includes at least one of the followings (N is maintained for each UE).

In operation 1, the network configures the ST support parameters for one DRB in the RRC message, where the ST support parameters include the counter N and the TX-side timer, etc.

In operation 2, the UE MAC performs counting mechanism for ST entering judgment. The details are as follows.
ST_COUNTER, a new UE variable to calculate the consecutive HARQ-NACKs, is initially set to 0.
If it is the first retransmission grant received when the TX-side timer is not running, the timer is started or restarted the timer, and ST_COUNTER is set to 1.
If one retransmission grant is received when the TX-side timer is running, the ST_COUNTER is incremented by 1.
If one new transmission grant is received, the ST_COUNTER is reset to 0 and the TX-side timer is stopped.
If the ST_COUNTER≥N before the TX-side timer expires, the ST_COUNTER is reset to 0 and the upper layer is indicated to activate the PDCP duplication.
If the ST_COUNTER<N when the TX-side timer expires, the ST_COUNTER is reset to 0.

In operation 3, the UE PDCP layer activates PDCP duplication once PDCP duplication activation indication, e.g. ST support, is received from the lower layer.

i. Optionally, the fourth example of the judgment flow (the usage of the timer has the differences in: 1, the timer is used per HARQ process; and 2, N HARQ feedbacks are for one HARQ process).

This example may include following three proposals.

For Proposal 1, when the counting number N is larger than 1, the RAN2 (i.e., the RAN2 meeting) considers the combination of the HARQ-NACK counting and the TX-side timer.

For Proposal 2, the HARQ-NACK counting number is required to be reset when the TX-side timer corresponding to the HARQ process expires.

For Proposal 3, the TX-side timer is interpreted as the CGT.

The following is one implementation of the combination of the HARQ-NACK counting and the TX-side timer in this example, which may include at least one of followings.

1) In operation 1, the network device configures ST-related parameters for one DRB via an RRC message, where the ST-related parameters include the counting number N and the ST enabler.

2) In operation 2, the UE MAC layer performs the judgment for the ST entering for this DRB. The details are as follows.
ST_COUNTER, a new variable to calculate the consecutive HARQ-NACKs, is initially set to 0 for each HARQ process.
The TX-side timer is started for the corresponding HARQ process when the initial transmission of the packet of the DRB is performed).

If one retransmission grant for the corresponding HARQ process is received when the TX-side timer is running, ST_COUNTER is incremented by 1 for the corresponding HARQ process.
If a new transmission grant for the corresponding HARQ process is received when the TX-side timer is running, ST_COUNTER is reset to 0 for the corresponding HARQ process.
If ST_COUNTER=N before the TX-side timer expiry, ST_COUNTER is reset to 0 for the corresponding HARQ process and the upper layer is indicated to activate PDCP duplication).
If ST_COUNTER<N upon the TX-side timer expiry, ST_COUNTER is reset to 0 for the corresponding HARQ process.

3) In operation 3, the PDCP layer of the UE activates PDCP duplication upon receiving the PDCP duplication activation indication.

i. Optionally, the fifth example of the judgment flow includes at least one of the followings (in which the timer is not required).

In operation 1, the network device configures ST support parameters for one DRB in the RRC message, where the ST support parameters include the ST support enabler and/or the counting number N.

In operation 2, the MAC layer of the UE performs counting mechanism for ST entering judgment. The details are as follows.
ST_COUNTER, a new UE variable to calculate the consecutive HARQ-NACKs, is initially set to 0.
If one retransmission grant is received, the ST_COUNTER is incremented by 1.
If a new transmission grant is received, the ST_COUNTER is reset to 0.
If the ST_COUNTER≥N, the ST_COUNTER is reset to 0, and the upper layer is indicated to activate the PDCP duplication.

In operation 3, the UE PDCP layer activates PDCP duplication once PDCP duplication activation indication, e.g. ST support, is received from the lower layer.

i. According to the order of the HARQ processes (such as the order of the HARQ processes maintained by the UE or the order of the HARQ processes calculated according to the formula), the UE determines whether the feedback for the former HARQ process is received or whether the feedback for the former HARQ process is the ACK (the former HARQ process, for which the feedback is not received, is considered to have the feedback of ACK) according to whether the feedback for the latter HARQ process is received or whether the feedback result for the latter HARQ process is the NACK.

The embodiment has the beneficial effect that the second problem is solved, and the ST requirement for the service transmission is guaranteed.

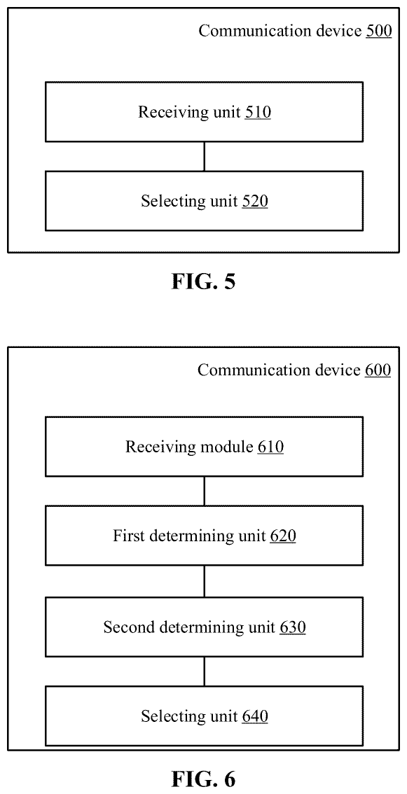

The method embodiments of the present disclosure are described in detail above with reference to FIG. 1 to FIG. 4 and the device embodiments of the present disclosure are described in detail below with reference to FIG. 5 to FIG. 8. It should be understood that the description of the method embodiments correspond to the description of the device embodiments and therefore portions not described in detail in the device embodiments may be referred to the method embodiments.

FIG. 5 is a schematic structural diagram of a communication device according to an embodiment of the present disclosure. The communication device 500 in FIG. 5 includes a receiving unit 510 and a selecting unit 520.

The receiving unit 510 is configured to receive first information, where the first information includes at least one of: a position of a CG resource, an HARQ process corresponding to the CG resource, a CGRT or an HARQ process selection manner.

The selecting unit 520 is configured to select a target HARQ process corresponding to the CG resource according to the first information.

The HARQ process selection manner is used for indicating the device to preferentially select an HARQ process for retransmission or an HARQ process with a higher priority.

Optionally, the selecting unit 520 is specifically configured to: if the HARQ process selection manner is not configured, the first information does not include the HARQ process selection manner or the HARQ process selection manner indicates the device to preferentially select the HARQ process for retransmission, preferentially select, among multiple HARQ processes, the HARQ process for retransmission as the target HARQ process.

Optionally, an HARQ process corresponding to an MAC PDU with a lower priority is considered as the HARQ process for retransmission, or the HARQ process corresponding to the MAC PDU with the lower priority is considered to be a new transmission HARQ process.

Optionally, the selecting unit 520 is specifically configured to: if the HARQ process selection manner indicates the device to preferentially select the HARQ process with the higher priority, preferentially select, among multiple HARQ processes, the HARQ process with the higher priority or an HARQ process corresponding to a higher Logical Channel Priority (LCP) as the target HARQ process.

Optionally, in a case where multiple preferential HARQ processes are present in the multiple HARQ processes, the selecting unit 520 is specifically configured to select the target HARQ process according to any one of following ways: selecting, among the multiple preferential HARQ processes, any one HARQ process as the target HARQ process; selecting, among the multiple preferential HARQ processes, an HARQ process with a smallest HARQ process index as the target HARQ process; selecting, among the multiple preferential HARQ processes, an HARQ process with a greatest HARQ process index as the target HARQ process; selecting, among the multiple preferential HARQ processes, the HARQ process for retransmission as the target HARQ process; selecting, among the multiple preferential HARQ processes, a new transmission HARQ process as the target HARQ process; selecting, among the multiple preferential HARQ processes, an HARQ process corresponding to an MAC PDU with a lower priority as the target HARQ process; selecting, among the multiple preferential HARQ processes, an HARQ process corresponding to a user DRB configured with an ST as the target HARQ process; selecting, among the multiple preferential HARQ processes, an HARQ process corresponding to a DRB with a higher ST requirement as the target HARQ process; selecting, among the multiple preferential HARQ processes, an HARQ process corresponding to a DRB that will not satisfy an ST requirement within a preset period of time as the target HARQ process; selecting, among the multiple preferential HARQ processes, an HARQ process having a number of HARQ retransmissions satisfying a first preset requirement as the target HARQ process; selecting, among the multiple preferential HARQ processes, an HARQ process including LCH data as the target HARQ process; or selecting, among the multiple preferential HARQ processes, the target HARQ process based on an implementation of the device.

Optionally, the selecting unit 520 is specifically configured to: determine, according to the first information, whether priorities of the HARQ processes are required to be determined; if the priorities of the HARQ processes are required to be determined, determine the priorities of the HARQ processes; and select, among the multiple HARQ processes, the target HARQ process corresponding to the CG resource according to the priorities.

Optionally, the selecting unit 520 is specifically configured to: if the HARQ process selection manner is not configured, the first information does not include the HARQ process selection manner or the HARQ process selection manner indicates the device to preferentially select the HARQ process for retransmission, be not required to determine the priorities of the HARQ processes; and if the HARQ process selection manner indicates the device to preferentially select the HARQ process with the higher priority, be required to determine the priorities of the HARQ processes.

Optionally, the selecting unit 520 is specifically configured to: determine the priorities of the HARQ processes according to any one of following ways.

If data is contained or to be contained in the HARQ process, or if an LCH is multiplexed or to be multiplexed in the HARQ process, the selecting unit 520 is configured to determine the priorities of the multiple HARQ processes according to priorities of LCHs.

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, the selecting unit 520 is configured to determine the priorities of the multiple HARQ processes according to a priority order of LCPs or a priority order of the MAC CEs.

If only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to a SR.

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but UCI is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.

FIG. 6 is a schematic structural diagram of a communication device according to an embodiment of the present disclosure. The communication device 600 in FIG. 6 includes a receiving unit 610, a first determining unit 620, a second determining unit 630, and a selecting unit 640.

The receiving unit 610 is configured to receive first information, where the first information includes at least one of: a position of a CG resource, an HARQ process corresponding to the CG resource, a CGRT or an HARQ process selection manner.

The first determining unit 620 is configured to determine, according to the first information, whether priorities of HARQ processes are required to be determined.

The second determining unit 630 is configured to determine the priorities of the HARQ processes if the priorities of the HARQ processes are required to be determined.

The selecting unit is configured to select, among multiple HARQ processes, a target HARQ process corresponding to the CG resource according to the priorities.

The HARQ process selection manner is used for indicating the device to preferentially select an HARQ process for retransmission or an HARQ process with a higher priority.

Optionally, the first determining unit 620 is configured to: if the HARQ process selection manner is not configured, the first information does not include the HARQ process selection manner or the HARQ process selection manner indicates the device to preferentially select the HARQ process for retransmission, be not required to determine the priorities of the HARQ processes; and if the HARQ process selection manner indicates the device to preferentially select the HARQ process with the higher priority, be required to determine the priorities of the HARQ processes.

Optionally, the second determination unit 630 is specifically configured to determine the priorities of the HARQ processes according to any one of following ways.

If data is contained or to be contained in the HARQ process, or if an LCH is multiplexed or to be multiplexed in the HARQ process, the second determining unit 630 is configured to determine the priorities of the multiple HARQ processes according to priorities of LCHs.

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, the second determining unit 630 is configured to determine the priorities of the multiple HARQ processes according to a priority order of LCPs or a priority order of the MAC CEs.

If only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to a SR.

If only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but Uplink Control Information (UCI) is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.

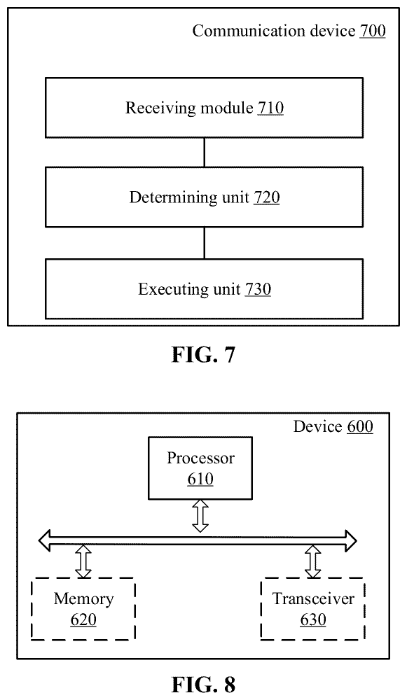

FIG. 7 is a schematic structural diagram of a communication device according to an embodiment of the present disclosure. As shown in FIG. 7, the device 700 includes a receiving unit 710, a determining unit 720, and an executing unit 730 as follows:

The receiving unit 710 is configured to receive second information, where the second information includes at least one of: an ST indication, an ST enable indication, a counter N, a maximum threshold of the counter N, a timer, an ID of a user DRB, an ID of a Quality of Service (QoS) flow or an ID of a Logical Channel (LCH), where N is a positive number.

The determining unit 720 is configured to determine, according to the second information, whether the device is required to satisfy an ST transmission requirement, whether to enter an ST state or whether to trigger a behavior corresponding to the ST state.

Optionally, the DRB is configured with an ST ID, the QoS flow is configured with the ST ID, and/or the LCH is configured with the ST ID.

Optionally, the second information further includes a CG resource or a DG resource used by the ST state.

Optionally, the maximum threshold of the counter N and/or the timer are determined according to at least one of: an ST, a PDB or a RTT duration.

Optionally, the second information is carried in a RRC message, an MAC CE, DCI, PDCP configuration information, DRB configuration information or LCH configuration information.

Optionally, the second information is carried in at least one of: PDCP configuration information, RB configuration information or LCH configuration information.

Optionally, the determining unit 720 is further configured to determine an association relationship among the DRB, the LCH and a scheduling grant according to at least one of the PDCP configuration information, the RB configuration information or the LCH configuration information.

Optionally, the determining unit 720 is specifically configured to determine, according to the second information, whether a target object triggers the behavior corresponding to the ST state, where the target object is the device, the DRB, the QoS flow or the LCH.

Optionally, the determining unit 720 is specifically configured to determine, according to the counter N and the timer, whether the device is required to satisfy the ST transmission requirement, whether to enter the ST state or whether to trigger the behavior corresponding to the ST state.

Optionally, the behavior corresponding to the ST state includes duplication or activation of the duplication.

Optionally, the determining unit 720 is specifically configured to: if the counter N reaches the maximum threshold before the timer expires, determine to satisfy the ST transmission requirement, to enter the ST state or to trigger the behavior corresponding to the ST state; if an Acknowledge (ACK) is received before the timer expires, determine not to satisfy the ST transmission requirement, not to enter the ST state or not to trigger the behavior corresponding to the ST state; and if the timer expires or if the counter N does not reach the maximum threshold before the timer expires, determine not to satisfy the ST transmission requirement, not to enter the ST state or not to trigger the behavior corresponding to the ST state.

Optionally, the device 700 further includes an executing unit 730 configured to: in a case it is determined to satisfy the ST transmission requirement, to enter the ST state or to trigger the behavior corresponding to the ST state, perform at least one of: stopping the timer, resetting the counter N, entering the ST state, triggering the duplication, indicating by an MAC layer to an upper layer that an NACK is received, activating the duplication, or satisfying an ST entry state.

Optionally, the device 700 also includes an executing unit 730 configured to: if a data packet transmission error is present before the timer expires, increment the counter N by 1.

Optionally, the executing unit 730 is further configured to: keep the counter N unchanged if multiple data packet transmission errors are directed to a same data packet, or if the multiple data packet transmission errors are directed to a same HARQ process, or if the multiple data packet transmission errors are directed to a same data packet during running of the timer, or if the multiple data packet transmission errors are directed to a same HARQ process during running of the timer; and increment the counter N by 1 if the multiple data packet transmission errors are directed to different data packets, or if the multiple data packet transmission errors are directed to different HARQ processes, or if the multiple data packet transmission errors are directed to different data packets during running of the timer, or if the multiple data packet transmission errors are directed to different HARQ processes during running of the timer.

Optionally, it is considered that the data packet transmission error is present when at least one of following conditions occurs.

A data packet is lost. An HARQ-NACK is received. A data packet corresponding to an ST is lost. An HARQ-NACK corresponding to the ST is received. The data packet is lost in a case where the timer is not running. The HARQ-NACK is received in a case where the timer is not running. The data packet corresponding to the ST is lost in a case where the timer is not running. The HARQ-NACK corresponding to the ST is received in a case where the timer is not running.

Optionally, the executing unit 730 is further configured to start the timer when the executing unit 730 performs at least one of the followings.

A data packet corresponding to an ST is sent. A data packet is received from an upper layer. A corresponding data packet is sent by a lower layer. A data packet is lost.

An HARQ-NACK is received. The data packet corresponding to the ST is discarded. An HARQ-NACK corresponding to the ST is received.

Optionally, the executing unit 730 is further configured to initialize the counter N when the executing unit 730 performs at least one of the followings.

A corresponding data packet is sent to a lower layer. A data packet is received from an upper layer. A lower layer sends a corresponding data packet. A data packet is lost. An HARQ-NACK is received. A data packet corresponding to an ST is discarded. An HARQ-NACK corresponding to an ST is received. A data packet is discarded in a case where the timer is not running. An HARQ-NACK is received in a case where the timer is not running. A data packet corresponding to an ST is discarded in a case where the timer is not running. An HARQ-NACK corresponding to an ST is received in a case where the timer is not running. Expiry of the timer. An ACK is received. An ACK corresponding to an ST is received.

Optionally, the executing unit 730 is further configured to: if a lower layer receives a DRB corresponding to an ST or an NACK feedback associated with an LCH, start the timer or restart the timer; if the DRB corresponding to the ST or a data packet associated with the LCH is received from the upper layer, start the timer or restart the timer; and if the DRB corresponding to the ST or the data packet associated with the LCH is sent, start the timer or restart the timer.

Optionally, the timer is directed to a corresponding data packet, or the timer is directed to a corresponding HARQ process, or the timer is directed to a corresponding CG resource, and the executing unit 730 is further configured to maintain the counter N based on the timer, or maintain the counter N for each timer.

Optionally, the executing unit 730 is further configured to: if one retransmission grant is received before the timer expires, increment the counter N by 1; if one new transmission grant is received before the timer expires, stop the timer; if the counter N reaches the maximum threshold before the timer expires, stop the timer, and/or enter the ST state, or trigger the ST state or trigger the duplication; and if the counter N does not reach the maximum threshold before the timer expires, stop the timer.

Optionally, the executing unit 730 is further configured to perform at least one of: if multiple retransmission grants are directed to a same data packet, or if the multiple retransmission grants are directed to a same HARQ process, or if the multiple retransmission grants are directed to a same data packet during running of the timer, or if the multiple retransmission grants are directed to a same HARQ process during running of the timer, keeping the counter N unchanged; or if the multiple retransmission grants are directed to different data packets, or if the multiple retransmission grants are directed to different HARQ processes, or if the multiple retransmission grants are directed to different data packets during running of the timer, or if the multiple retransmission grants are directed to different HARQ processes during running of the timer, incrementing the counter N by 1.

Optionally, the timer is a TX-side timer or an RX-side timer.

Optionally, the executing unit 730 is further configured to trigger the duplication if it is indicated by the lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer.

Optionally, the executing unit 730 is further configured to: if a lower layer receives a DRB corresponding to an ST or an NACK feedback associated with an LCH, start the timer; if the DRB corresponding to the ST or a data packet associated with the LCH is received from the upper layer, start the timer; and if the DRB corresponding to the ST or the data packet associated with the LCH is sent, start the timer.

Optionally, the timer is directed to a terminal device, or the counter N is maintained for each terminal device.

Optionally, the executing unit 730 is further configured to: if one retransmission grant is received when the timer is not running, increment the counter N by 1, and start the timer.

Optionally, the executing unit 730 is further configured to: if one retransmission grant is received during running of the timer, increment the counter N by 1; if one new transmission grant is received during running of the timer, stop the timer and reset the counter N; if the counter N reaches the maximum threshold before the timer expires, reset the counter N, and/or stop the timer, and/or enter the ST state, trigger the ST state or trigger the duplication; and if the counter N does not reach the maximum threshold before the timer expires, reset the counter N.

Optionally, the executing unit 730 is further configured to perform at least one of: if multiple retransmission grants are directed to a same data packet, or if the multiple retransmission grants are directed to a same HARQ process, or if the multiple retransmission grants are directed to a same data packet during running of the timer, or if the multiple retransmission grants are directed to a same HARQ process during running of the timer, keeping the counter N unchanged; or if the multiple retransmission grants are directed to different data packets, or if the multiple retransmission grants are directed to different HARQ processes, or if the multiple retransmission grants are directed to different data packets during running of the timer, or if the multiple retransmission grants are directed to different HARQ processes during running of the timer, incrementing the counter N by 1.

Optionally, the timer is a TX-side timer or an RX-side timer.

Optionally, the executing unit 730 is further configured to trigger the duplication if it is indicated by a lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer.

Optionally, the executing unit 730 is further configured to: if a lower layer receives a DRB corresponding to an ST or an NACK feedback associated with an LCH, start the timer; if the DRB corresponding to the ST or a data packet associated with the LCH is received from the upper layer, start the timer; and if the DRB corresponding to the ST or the data packet associated with the LCH is sent, start the timer.

Optionally, the timer is directed to each HARQ process, or the counter N is maintained for each HARQ process.

Optionally, the executing unit 730 is further configured to: if one retransmission grant is received when the timer is not running, increment the counter N by 1, and start the timer.

Optionally, the executing unit 730 is further configured to: if one retransmission grant is received during running of the timer, increment the counter N by 1; if one new transmission grant is received during running of the timer, reset the counter N; if the counter N reaches the maximum threshold before the timer expires, reset the counter N, and/or stop the timer, and/or enter the ST state, trigger the ST state or trigger the duplication; and if the counter N does not reach the maximum threshold before the timer expires, reset the counter N.

Optionally, the executing unit 730 is further configured to perform at least one of: if multiple retransmission grants are directed to a same data packet, or if the multiple retransmission grants are directed to a same data packet during running of the timer, updating or maintaining the counter N; or if the multiple retransmission grants are directed to different packets, or if the multiple retransmission grants are directed to different packets during running of the timer, keeping the counter N unchanged.

Optionally, the timer is a TX-side timer or an RX-side timer.

Optionally, the executing unit 730 is further configured to trigger the duplication if it is indicated by a lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer.

Optionally the determining unit 720 is specifically configured to determine, according to the counter N, whether to enter the ST state or whether to trigger the behavior corresponding to the ST state.

Optionally, the executing unit 730 is further configured to: if one retransmission grant is received, increment the counter N by 1; if one new transmission grant is received, reset the counter N; and if the counter N reaches the maximum threshold, reset the counter N; and/or enter the ST state, trigger the ST state or trigger the duplication.

Optionally, if multiple retransmission grants are directed to a same data packet, or if the multiple retransmission grants are directed to a same HARQ process, or if the multiple retransmission grants are directed to a same data packet during running of the timer, or if the multiple retransmission grants are directed to a same HARQ process during running of the timer, the executing unit 730 is further configured to keep the counter N unchanged; and if the multiple retransmission grants are directed to different data packets, or if the multiple retransmission grants are directed to different HARQ processes, or if the multiple retransmission grants are directed to different data packets during running of the timer, or if the multiple retransmission grants are directed to different HARQ processes during running of the timer, the executing unit 730 is further configured to increment the counter N by 1.

Optionally, the executing unit 730 is further configured to trigger the duplication if it is indicated by a lower layer to enter the ST state, or to trigger the ST state or to trigger activation of duplication corresponding to an ST, or if an indication to enter the ST state, or to trigger the ST state or to trigger activation of duplication corresponding to the ST is received from the lower layer.

FIG. 8 is a schematic structural diagram of a device according to an embodiment of the present disclosure. The dotted line in FIG. 8 indicates that the unit or module is optional. The device 600 may be configured to implement the methods described in the method embodiments. The device 600 may be a chip or a communication device.

The device 600 may include one or more processors 610. The processor 610 may support the device 600 to implement the methods described in the method embodiments. The processor 610 may be a general purpose processor or a special purpose processor. For example, the processor may be a Central Processing Unit (CPU). Optionally, the processor may also be other general purpose processors, Digital Signal Processor (DSP), Application Specific Integrated Circuit (ASIC), Field Programmable Gate Array (FPGA) or other programmable logic devices, discrete gate or transistor logic devices, discrete hardware components, and the like. The general purpose processor may be a microprocessor or the processor may be any conventional processor or the like.

The device 600 may also include one or more memories 620. The memory 620 stores programs that can be executed by the processor 610 such that the processor 610 performs the methods described in the method embodiments. The memory 620 may be independent of or integrated into the processor 610.

The device 600 may also include a transceiver 630. The processor 610 may communicate with other devices or chips through the transceiver 630. For example, the processor 610 may send data to and receive data from other devices or chips through the transceiver 630.

The embodiment of the present disclosure also provides a computer-readable storage medium configured to store programs. The computer-readable storage medium may be applied to the communication device provided by the embodiment of the present disclosure, and the programs cause a computer to perform the methods performed by the communication device in the various embodiments of the present disclosure.

The embodiment of the present disclosure also provides a computer program product. The computer program product includes programs. The computer program product may be applied to the communication device provided by the embodiment of the present disclosure, and the programs cause a computer to perform the methods performed by the communication device in various embodiments of the present disclosure.

The embodiment of the present disclosure also provides a computer program. The computer program may be applied to the communication device provided by the embodiment of the present disclosure, and the computer program causes the computer to perform the methods performed by the communication device in the various embodiments of the present disclosure.

It should be understood that, in the embodiments of the present disclosure, the expression “B corresponding to A” means that B is associated with A and B may be determined according to A. It should also be understood, however, the meaning that B may be determined according to A does not mean that B is determined according to A alone, but may also be determined according to A and/or other information.

It should be understood that the term “and/or” is only to describe an association relationship between associated objects and represents that three kinds of relationships may exist. For example, A and/or B may represent three conditions: i.e., independent existence of A, existence of both A and B and independent existence of B. In addition, the character “/” in the present disclosure generally indicates that the associated objects before and after this character is in an “or” relationship.

It should be understood that, in various embodiments of the present disclosure, the sequence numbers of the above processes do not imply the sequence of execution, and the sequence of execution of each process should be determined according to its functions and internal logic, and should not constitute any limitation on the implementation process of the embodiments of the present disclosure.

In the several embodiments provided in the disclosure, it should be understood that the disclosed system, apparatus, and method may be implemented in other modes. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions of the embodiments.

In addition, functional units in various embodiments of the disclosure may be integrated into one processing unit, or each of the units may be physically separated, or two or more units may be integrated into one unit.

The above-described embodiments may be implemented in whole or in part by software, hardware, firmware or any combination thereof. When implemented in software, they may be implemented in whole or in part in the form of a computer program product. The computer program product includes one or more computer instructions. When the computer program instructions are loaded and executed on a computer, the flows or functions according to the embodiments of the disclosure are generated in whole or in part. The computer may be a general purpose computer, a dedicated computer, a computer network, or other programmable devices. The computer instructions may be stored in a computer-readable storage medium or transmitted from one computer-readable storage medium to another. For example, the computer instructions may be transmitted from one Web site, computer, server, or data center to another Web site, computer, server, or data center in a wired (e.g. coaxial cable, optical fiber, digital subscriber line (DSL)) manner or wireless (e.g. infrared, wireless, microwave, etc.) manner. The computer-readable storage medium may be any available medium that a computer may access or a datan STorage device such as a server, a data center, or the like that contains one or more integrations of available medium. The available medium may be magnetic medium (e.g. floppy disk, hard disk, magnetic tape), optical medium (e.g. DVD), or semiconductor medium (e.g. Solid State Disk (SSD)), etc.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure shall be subject to the scope of protection of the claims.

1. A communication method, comprising:
receiving, by a terminal device, first information, wherein the first information comprises at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and
selecting, by the terminal device, a target HARQ process corresponding to the CG resource according to the first information,
wherein the HARQ process selection manner is used for indicating the terminal device to preferentially select an HARQ process for retransmission or an HARQ process with a higher priority.

2. The method of claim 1, wherein selecting, by the terminal device, the target HARQ process according to the first information comprises:
if the HARQ process selection manner indicates the terminal device to preferentially select the HARQ process with the higher priority, preferentially selecting, by the terminal device among a plurality of HARQ processes, the HARQ process with the higher priority or an HARQ process corresponding to a higher Logical Channel Priority (LCP) as the target HARQ process.

3. The method of claim 2, wherein in a case where a plurality of preferential HARQ processes are present in the plurality of HARQ processes, selecting, by the terminal device, the target HARQ process corresponding to the CG resource according to the first information comprises:
selecting, by the terminal device, the target HARQ process according to any one of following ways:
selecting, among the plurality of preferential HARQ processes, any one HARQ process as the target HARQ process;
selecting, among the plurality of preferential HARQ processes, an HARQ process with a smallest HARQ process index as the target HARQ process;
selecting, among the plurality of preferential HARQ processes, an HARQ process with a greatest HARQ process index as the target HARQ process;
selecting, among the plurality of preferential HARQ processes, the HARQ process for retransmission as the target HARQ process;
selecting, among the plurality of preferential HARQ processes, a new transmission HARQ process as the target HARQ process;
selecting, among the plurality of preferential HARQ processes, an HARQ process corresponding to an MAC PDU with a lower priority as the target HARQ process;
selecting, among the plurality of preferential HARQ processes, an HARQ process corresponding to a user Data Radio Bearer (DRB) configured with a Survival Time (ST) as the target HARQ process;
selecting, among the plurality of preferential HARQ processes, an HARQ process corresponding to a DRB with a higher ST requirement as the target HARQ process;
selecting, among the plurality of preferential HARQ processes, an HARQ process corresponding to a DRB that will not satisfy an ST requirement within a preset period of time as the target HARQ process;
selecting, among the plurality of preferential HARQ processes, an HARQ process having a number of HARQ retransmissions satisfying a first preset requirement as the target HARQ process;
selecting, among the plurality of preferential HARQ processes, an HARQ process comprising Logical Channel (LCH) data as the target HARQ process; or
selecting, among the plurality of preferential HARQ processes, the target HARQ process based on an implementation of the terminal device.

4. The method of claim 2, wherein selecting, by the terminal device, the target HARQ process according to the first information comprises:
determining, by the terminal device according to the first information, whether priorities of the HARQ processes are required to be determined;
if the priorities of the HARQ processes are required to be determined, determining, by the terminal device, the priorities of the HARQ processes; and
selecting, by the terminal device among the plurality of HARQ processes, the target HARQ process corresponding to the CG resource according to the priorities.

5. The method of claim 3, wherein selecting, by the terminal device, the target HARQ process according to the first information comprises:
determining, by the terminal device according to the first information, whether priorities of the HARQ processes are required to be determined;
if the priorities of the HARQ processes are required to be determined, determining, by the terminal device, the priorities of the HARQ processes; and
selecting, by the terminal device among the plurality of HARQ processes, the target HARQ process corresponding to the CG resource according to the priorities.

6. The method of claim 4, wherein determining, by the terminal device according to the first information, whether the priorities of the HARQ processes are required to be determined comprises:
if the HARQ process selection manner is not configured, the first information does not comprise the HARQ process selection manner or the HARQ process selection manner indicates the terminal device to preferentially select the HARQ process for retransmission, the terminal device is not required to determine the priorities of the HARQ processes; and
if the HARQ process selection manner indicates the terminal device to preferentially select the HARQ process with the higher priority, the terminal device is required to determine the priorities of the HARQ processes.

7. The method of claim 4, wherein determining, by the terminal device, the priorities of the HARQ processes comprises:
determining, by the terminal device, the priorities of the HARQ processes according to any one of following ways:
if data is contained or to be contained in the HARQ process, or if an LCH is multiplexed or to be multiplexed in the HARQ process, determining the priorities of the plurality of HARQ processes according to priorities of LCHs;
if only padding information and/or Media Access Control Control Elements (MAC CEs) are contained or to be contained in the HARQ process corresponding to the CG resource or in the HARQ process, or if no data is multiplexed or to be multiplexed in the HARQ process, or if no LCH is multiplexed or to be multiplexed in the HARQ process, determining the priorities of the plurality of HARQ processes according to a priority order of LCPs or a priority order of the MAC CEs;
if only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to a Scheduling Request (SR); or
if only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but Uplink Control Information (UCI) is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.

8. A communication device, comprising:
a processor, a memory and a transceiver, wherein the memory is configured to store computer-executable instructions; and the processor is configured to invoke and run the computer-executable instructions stored in the memory to perform operations of:
receiving, through the transceiver, first information, wherein the first information comprises at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and
selecting a target HARQ process corresponding to the CG resource according to the first information,
wherein the HARQ process selection manner is used for indicating the device to preferentially select an HARQ process for retransmission or an HARQ process with a higher priority.

9. The device of claim 8, wherein selecting the target HARQ process according to the first information comprises:
if the HARQ process selection manner indicates the device to preferentially select the HARQ process with the higher priority, preferentially selecting, among a plurality of HARQ processes, the HARQ process with the higher priority or an HARQ process corresponding to a higher Logical Channel Priority (LCP) as the target HARQ process.

10. The device of claim 9, wherein in a case where a plurality of preferential HARQ processes are present in the plurality of HARQ processes, selecting the target HARQ process corresponding to the CG resource according to the first information comprises:
selecting the target HARQ process according to any one of following ways:
selecting, among the plurality of preferential HARQ processes, any one HARQ process as the target HARQ process;
selecting, among the plurality of preferential HARQ processes, an HARQ process with a smallest HARQ process index as the target HARQ process;
selecting, among the plurality of preferential HARQ processes, an HARQ process with a greatest HARQ process index as the target HARQ process;
selecting, among the plurality of preferential HARQ processes, the HARQ process for retransmission as the target HARQ process;
selecting, among the plurality of preferential HARQ processes, a new transmission HARQ process as the target HARQ process;
selecting, among the plurality of preferential HARQ processes, an HARQ process corresponding to an MAC PDU with a lower priority as the target HARQ process;
selecting, among the plurality of preferential HARQ processes, an HARQ process corresponding to a user Data Radio Bearer (DRB) configured with a Survival Time (ST) as the target HARQ process;
selecting, among the plurality of preferential HARQ processes, an HARQ process corresponding to a DRB with a higher ST requirement as the target HARQ process;
selecting, among the plurality of preferential HARQ processes, an HARQ process corresponding to a DRB that will not satisfy an ST requirement within a preset period of time as the target HARQ process;
selecting, among the plurality of preferential HARQ processes, an HARQ process having a number of HARQ retransmissions satisfying a first preset requirement as the target HARQ process;
selecting, among the plurality of preferential HARQ processes, an HARQ process comprising Logical Channel (LCH) data as the target HARQ process; or
selecting, among the plurality of preferential HARQ processes, the target HARQ process based on an implementation of the device.

11. The device of claim 9, wherein selecting the target HARQ process according to the first information comprises:
determining, according to the first information, whether priorities of the HARQ processes are required to be determined;
if the priorities of the HARQ processes are required to be determined, determining the priorities of the HARQ processes; and
selecting, among the plurality of HARQ processes, the target HARQ process corresponding to the CG resource according to the priorities.

12. The device of claim 10, wherein selecting the target HARQ process according to the first information comprises:
determining, according to the first information, whether priorities of the HARQ processes are required to be determined;
if the priorities of the HARQ processes are required to be determined, determining the priorities of the HARQ processes; and
selecting, among the plurality of HARQ processes, the target HARQ process corresponding to the CG resource according to the priorities.

13. The device of claim 11, wherein determining, according to the first information, whether the priorities of the HARQ processes are required to be determined comprises:
if the HARQ process selection manner is not configured, the first information does not comprise the HARQ process selection manner or the HARQ process selection manner indicates the device to preferentially select the HARQ process for retransmission, the communication device is not required to determine the priorities of the HARQ processes; and
if the HARQ process selection manner indicates the device to preferentially select the HARQ process with the higher priority, the communication device is required to determine the priorities of the HARQ processes.

14. The device of claim 11, wherein determining the priorities of the HARQ processes comprises:
determining the priorities of the HARQ processes according to any one of following ways:
if data is contained or to be contained in the HARQ process, or if an LCH is multiplexed or to be multiplexed in the HARQ process, determining the priorities of the plurality of HARQ processes according to priorities of LCHs;
if only padding information and/or Media Access Control Control Elements (MAC CEs) are contained or to be contained in the HARQ process corresponding to the CG resource or in the HARQ process, or if no data is multiplexed or to be multiplexed in the HARQ process, or if no LCH is multiplexed or to be multiplexed in the HARQ process, determining the priorities of the plurality of HARQ processes according to a priority order of LCPs or a priority order of the MAC CEs;
if only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to a Scheduling Request (SR); or
if only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but Uplink Control Information (UCI) is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.

15. A chip, comprising a processor configured to invoke programs from a memory, to enable a device on which the chip is mounted to perform operations of:
receiving first information, wherein the first information comprises at least one of: a position of a Configured Grant (CG) resource, a Hybrid Automatic Repeat reQuest (HARQ) process corresponding to the CG resource, a Configured Grant Retransmission Timer (CGRT) or an HARQ process selection manner; and
selecting a target HARQ process corresponding to the CG resource according to the first information,
wherein the HARQ process selection manner is used for indicating the device to preferentially select an HARQ process for retransmission or an HARQ process with a higher priority.

16. The chip of claim 15, wherein selecting the target HARQ process according to the first information comprises:
if the HARQ process selection manner indicates the device to preferentially select the HARQ process with the higher priority, preferentially selecting, among a plurality of HARQ processes, the HARQ process with the higher priority or an HARQ process corresponding to a higher Logical Channel Priority (LCP) as the target HARQ process.

17. The chip of claim 16, wherein in a case where a plurality of preferential HARQ processes are present in the plurality of HARQ processes, selecting the target HARQ process corresponding to the CG resource according to the first information comprises:
selecting the target HARQ process according to any one of following ways:
selecting, among the plurality of preferential HARQ processes, any one HARQ process as the target HARQ process;
selecting, among the plurality of preferential HARQ processes, an HARQ process with a smallest HARQ process index as the target HARQ process;
selecting, among the plurality of preferential HARQ processes, an HARQ process with a greatest HARQ process index as the target HARQ process;
selecting, among the plurality of preferential HARQ processes, the HARQ process for retransmission as the target HARQ process;
selecting, among the plurality of preferential HARQ processes, a new transmission HARQ process as the target HARQ process;
selecting, among the plurality of preferential HARQ processes, an HARQ process corresponding to an MAC PDU with a lower priority as the target HARQ process;
selecting, among the plurality of preferential HARQ processes, an HARQ process corresponding to a user Data Radio Bearer (DRB) configured with a Survival Time (ST) as the target HARQ process;
selecting, among the plurality of preferential HARQ processes, an HARQ process corresponding to a DRB with a higher ST requirement as the target HARQ process;
selecting, among the plurality of preferential HARQ processes, an HARQ process corresponding to a DRB that will not satisfy an ST requirement within a preset period of time as the target HARQ process;
selecting, among the plurality of preferential HARQ processes, an HARQ process having a number of HARQ retransmissions satisfying a first preset requirement as the target HARQ process;
selecting, among the plurality of preferential HARQ processes, an HARQ process comprising Logical Channel (LCH) data as the target HARQ process; or
selecting, among the plurality of preferential HARQ processes, the target HARQ process based on an implementation of the device.

18. The chip of claim 16, wherein selecting the target HARQ process according to the first information comprises:
determining, according to the first information, whether priorities of the HARQ processes are required to be determined;
if the priorities of the HARQ processes are required to be determined, determining the priorities of the HARQ processes; and
selecting, among the plurality of HARQ processes, the target HARQ process corresponding to the CG resource according to the priorities.

19. The chip of claim 18, wherein determining, according to the first information, whether the priorities of the HARQ processes are required to be determined comprises:
if the HARQ process selection manner is not configured, the first information does not comprise the HARQ process selection manner or the HARQ process selection manner indicates the device to preferentially select the HARQ process for retransmission, the communication device is not required to determine the priorities of the HARQ processes; and
if the HARQ process selection manner indicates the device to preferentially select the HARQ process with the higher priority, the communication device is required to determine the priorities of the HARQ processes.

20. The chip of claim 18, wherein determining the priorities of the HARQ processes comprises:
determining the priorities of the HARQ processes according to any one of following ways:
if data is contained or to be contained in the HARQ process, or if an LCH is multiplexed or to be multiplexed in the HARQ process, determining the priorities of the plurality of HARQ processes according to priorities of LCHs;
if only padding information and/or Media Access Control Control Elements (MAC CEs) are contained or to be contained in the HARQ process corresponding to the CG resource or in the HARQ process, or if no data is multiplexed or to be multiplexed in the HARQ process, or if no LCH is multiplexed or to be multiplexed in the HARQ process, determining the priorities of the plurality of HARQ processes according to a priority order of LCPs or a priority order of the MAC CEs;
if only padding information and/or MAC CEs are contained or to be contained in the HARQ process corresponding to the CG resource or in the HARQ process, or if no data is multiplexed or to be multiplexed in the HARQ processes, or if no LCH is multiplexed or to be multiplexed in the HARQ process, then a priority of the HARQ process is low, or the priority of the HARQ process is lower than a priority of the HARQ process where the LCH is multiplexed or to be multiplexed, or the priority of the HARQ process is lower than priorities of other HARQ processes, or the priority of the HARQ process is lower than a priority of an HARQ process corresponding to a Scheduling Request (SR); or
if only padding information and/or MAC CEs are contained or to be contained in the HARQ process corresponding to the CG resource or in the HARQ process, or if no data is multiplexed or to be multiplexed in the HARQ process, or if no LCH is multiplexed or to be multiplexed in the HARQ process, but Uplink Control Information (UCI) is multiplexed in the HARQ process, then a priority of the HARQ process is a specific priority, or the priority of the HARQ process is low, or the priority of the HARQ process is lower than the priority of the HARQ process where the LCH is multiplexed or to be multiplexed, or the priority of the HARQ process is lower than priorities of other HARQ processes, or the priority of the HARQ process is lower than the priority of the HARQ process corresponding to the SR.
